(19) United States
(12) Patent Application Publication
(10) Pub. No.: US 2008/0210326 A1
(43) Pub. Date: Sep. 4, 2008

(54) Control Valve with Vortex Chambers

(76) Inventors: Douglas Goulet, Hanover, MN (US); Daniel Theodore Noes, Coon Rapids, MN (US); Steven Freitas, Mission Viejo, CA (US)

Correspondence Address: PYLE & PIONTEK LLC, 221 N. LASALLE STREET, SUITE 2036, CHICAGO, IL, 60601, US

(21) Appl. No.: 11/597,724

(22) PCT Filed: May 6, 2005
(86) PCT No.: PCT/GB05/01711

§ 371 Date: Nov. 27, 2006

(30) Foreign Application Priority Data
May 28, 2004 (GB) 0411921.0

(51) Int. Cl. F15C 1/16; F16L 55/027

(52) U.S. Cl. 138/43; 138/42; 137/810; 138/46

(57) ABSTRACT

A fluid flow control valve comprises a plurality of vortex, fluid pressure reduction chambers 1, each vortex chamber having an inlet in the form of a curved flowpath 2 having an inlet orifice 3 of defined cross sectional area which decreases along the length of the inlet flowpath to a minimum point at a throat 4 close to which it opens into the vortex chamber 1. The fluid flow within the vortex chamber takes a generally spiral flow path having both radial and axial components from the throat 4 towards an outlet 5 positioned substantially axially at an end of the vortex chamber, the curvature of the inlet flowpath being such that the direction of the flow therein is in substantially the same direction as the radial component of the flow within the vortex chamber.

This invention relates to the control and reduction of fluid pressure in control valves, especially but not exclusively severe service valves for use in power industries.

The most widely used technology in severe service valves utilises pressure letdown chambers consisting of one or more flow passages containing multiple orifice opening, labyrinths, or abrupt angular turn passageways resulting in a staged pressure reduction. Alternatively, flow restrictions can be afforded by physically reducing the flow passage area through which the fluid passes. As the fluid flows through these physical restrictions the velocity is locally increased at the restriction outlets generating turbulence which dissipates energy and reduces the pressure.

In the afore-mentioned control valves, dissipation of the energy of the flowing fluid is effected by frictional drag through smooth round passages, or by successive abrupt restrictions and expansions through tortuous passages. Some of these arrangements have noise problems associated with them, and since they rely largely on frictional losses, performance is quite susceptible to viscosity changes which are an inherent result of temperature changes. Another problem associated with these technologies is that the energy dissipated through the physical flow restrictions can result in physical damage or erosion to valve components if not controlled in a careful manner.

An alternative technology is disclosed in U.S. Pat. Nos. 3,941,350 and 3,780,767, namely high resistance vortex chamber passage trims, which offers some noise reduction. In vortex designs the pressure reduction occurs by accelerating the fluid in the vortex. As the fluid spirals towards the outlets it accelerates and the pressure drops. In the above existing vortex pressure reduction designs the fluid enters the vortex at full pressure and only accelerates once inside the vortex. Thus, noise still tends to be a problem. This is addressed in UK patent specification No 1 486 440 which discloses vortex chamber pressure reduction utilising a curved inlet flowpath such that the acceleration of the fluid and associated pressure reduction starts to occur before it enters the vortex chamber. However, the proposals therein can still result in noise, albeit to a lesser extent, at the outlet.

It is an object of the present invention to solve or at least mitigate the above-mentioned problems associated with known vortex chamber designs of control valves.

According to a first aspect of the invention there is provided a fluid flow control valve including a plurality of vortex pressure reduction chambers each having an inlet flowpath which opens into its associated vortex chamber, the inlet flowpath having a cross sectional area which decreases along the length of the inlet flowpath to a minimum point where it opens into the vortex chamber thereby, in use, accelerating the fluid flow through the reducing cross sectional area flowpath prior to it entering the vortex chamber, the fluid flow within the vortex chamber taking a generally spiral flow path having both radial and axial components towards an outlet positioned axially at one end of the radial chamber.

The inlet flowpath is preferably curved.

In a preferred arrangement the vortex chamber is substantially cylindrical and the outlet is positioned on, and at one end of, the central axis of the chamber, the outlet being smaller in cross sectional area than the end of the vortex chamber.

In an alternative preferred arrangement the vortex chamber is substantially cylindrical and the outlet is positioned on, and at one end of, the central axis of the chamber, the outlet being substantially equal in cross sectional area to the end of the vortex chamber.

Where the vortex chamber is substantially cylindrical, the inlet flow into the vortex chamber from the inlet flowpath is preferably substantially tangential to the surface of the vortex chamber, thereby minimising any turbulence at the point of entry of the fluid into the vortex chamber, and the outlet is positioned on, and at one end of, the central axis of the chamber. In plan therefore, the inlet flowpath and the vortex chamber preferably resemble a figure “9”.

In an alternative preferred arrangement the vortex chamber is substantially in the shape of a spiral, the spiral reducing from the point of entry of the fluid to the outlet which may preferably be offset from the central axis. Preferably the tail of the spiral continues in curvature to form the inlet flowpath.

In a preferred arrangement the vortex chamber has at least one inlet for the fluid and two outlets for the fluid. In accordance with the this arrangement, therefore, the fluid is introduced under pressure into a vortex chamber via the inlet flowpath and, within the chamber, the fluid flow splits in two and takes a generally spiral flow path having both radial and axial components towards each of two outlets which are preferably opposed to one another, the radial velocity of the fluid increasing with decreasing radius of the spiral flow path. The dual outlets offer significant advantages over the prior art in that the exit velocity is dramatically reduced and so are less likely to reach the extreme levels which cause cavitation.

According to a second aspect of the invention there is provided a trim for a fluid flow control valve according to the first aspect of the invention, the trim being of the stacked disc type and the plurality of vortex chambers being defined by the discs. The vortex chambers in the discs can be of varying dimensions allowing the level of resistance produced by the trim to profile the valve's performance over the entire actuation stroke of the control valve. Preferably, the vortex chambers are located radially on a disc with a central concentric hole, the fluid inlet and fluid outlets being located on, respectively, the inner and outer diameters of the disc. The discs may each consist of one or more elements placed on top of one another with different details machined on or in their surfaces to create the desired geometry of the vortex chambers and the fluid inlet and fluid outlets.

Preferably, the discs are brazed or joined together by other means to form a disc stack control element in the shape of a cylinder with a concentric bore running along its axis and a plurality of fluid inlets and fluid outlets located on the inner and outer surfaces of the disc stack. Preferably, a plug or plunger is movable in the central bore of the disc stack such that it can cover and expose a varying number of fluid flow paths with associated pressure reducing chambers thereby enabling fine control of pressure reduction.

Preferably, the outlets of the vortex chambers in a disc stack are in communication with one another. This communication allows for a further subdivision of the fluid flow up as it passes up the disc stack into vortex chambers above those the inlets of which are exposed by the plug or plunger. Subdividing the fluid flow in this manner reduces the flow's velocity and therefore reduces the noise output. If the valve plug or plunger has lifted to its maximum lift exposing all the vortex inlets of the disc stack, the communication between vortex chambers will become an impingement point for the fluid flow passageways, reducing the communication of fluid but forming an impingement point adding further backpressure or high resistances to the flow. Lastly the communication between the outlets also reduces the potential for erosion in the outlet flow passageway.

In a valve of the invention, two or more dual-outlet vortex chambers may be joined in series with one another, thereby forming a staged velocity control valve, with the two outlets of one vortex chamber being connected to, respectively, the inlets of two of a second series of dual-outlet vortex chambers. This pattern may then be repeated to form as many chambers in series as one desires. Furthermore by varying the ratio of cross sectional area of outlets of one series to inlets of the next it is possible to control the fluid expansion, and therefore the fluid velocity, in the outlet orifice and passageway.

In preferred arrangements, two or three stage passageways provide the majority of the control valve needs in velocity control, but single stage and more then three stage designs can easily be produced with this invention.

Preferably the discs in the stack all use the same vortex chamber design but combining two or more chamber designs can in some cases provide a packaging advantage and a more tailored performance of the disc stack such that the pressure reduction/plunger displacement curve of a valve can be characterised to suit a particular control requirement. Preferably, in a valve of the invention the vortex chambers are used in conjunction with known (e.g. our “DRAG”) valve technology wherein, placed in the outlet flow from the vortex chamber, is a labyrinthine or like flowpath. Preferably this flowpath comprises a series of bends, allowing the fluid to fully expand within the disc which reduces any noise created by the expansion of the fluid as it exits the discs.

Preferably the bends are dimensioned such that the fluid flow passing through them does so at an angle of less than 90 degrees, enabling the fluid to fully expand without any additional pressure drop.

Preferably the outlet path from the vortex chambers is of increasing cross sectional area, aiding the fluid to expand fully and therefore reducing noise as the fluid exits the vortex outlet.

Embodiments of the invention will now be described, by way of example only, with reference to the accompanying drawings in which:

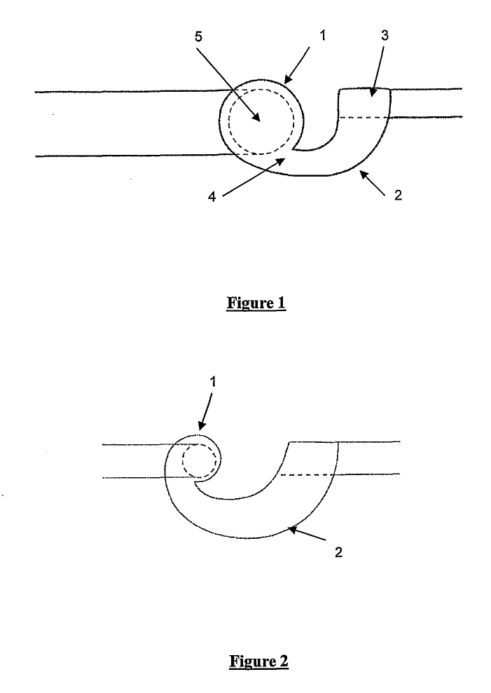

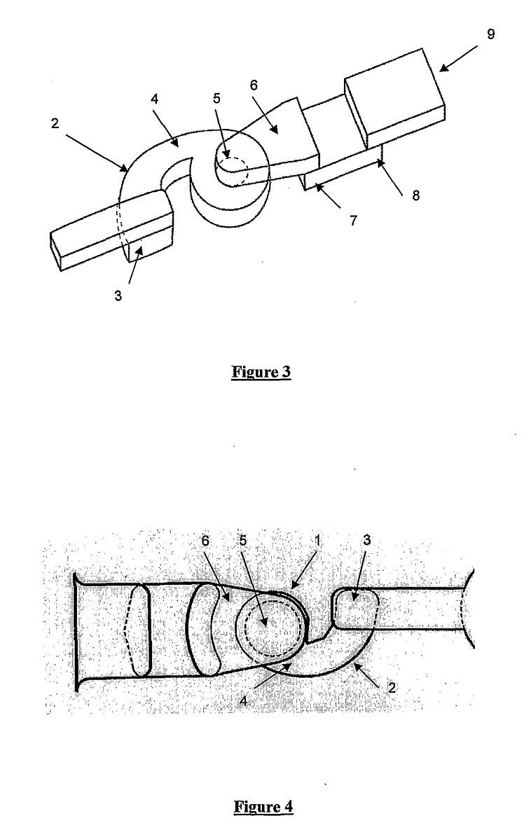

FIG. 1 and 2 are plan views of a vortex chamber of a control valve of the invention;

FIGS. 3 and 4 show a plan view and a perspective view respectively of the construction of a vortex chamber with associated outlet labyrinth;

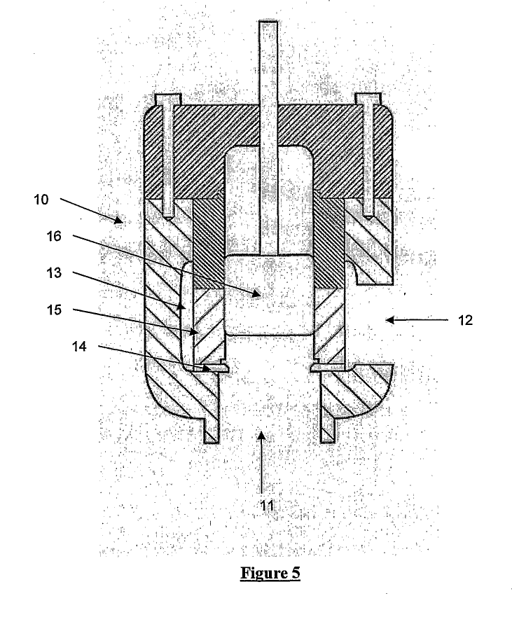

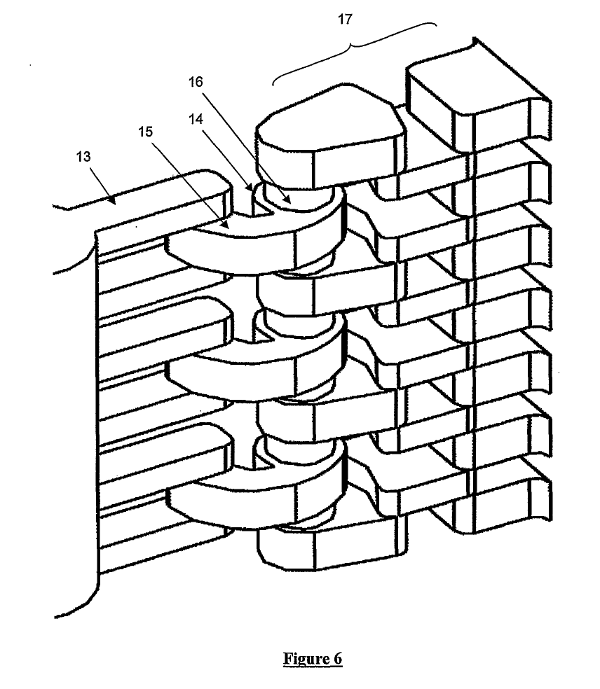

FIG. 5 is a vertical section showing the construction of a control valve incorporating a stacked plate disk stack trim as common in the art;

FIG. 6 is a diagram showing the construction of outlet communication between the vortex chambers;

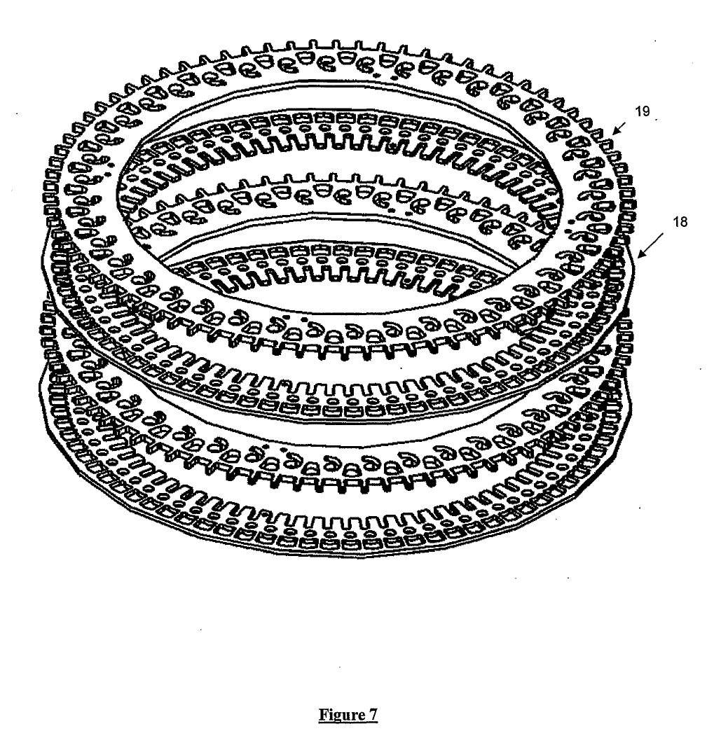

FIG. 7 is an exploded diagram showing the construction of a vortex chamber disk stack;

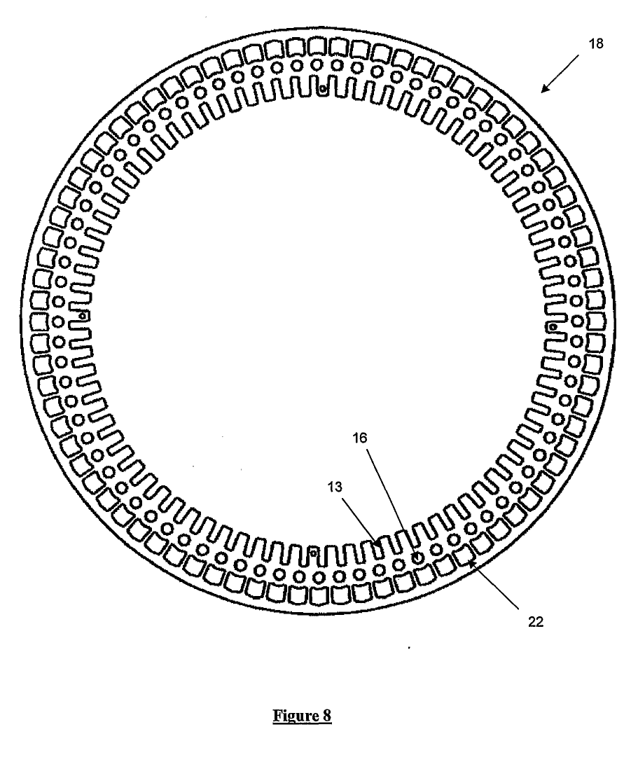

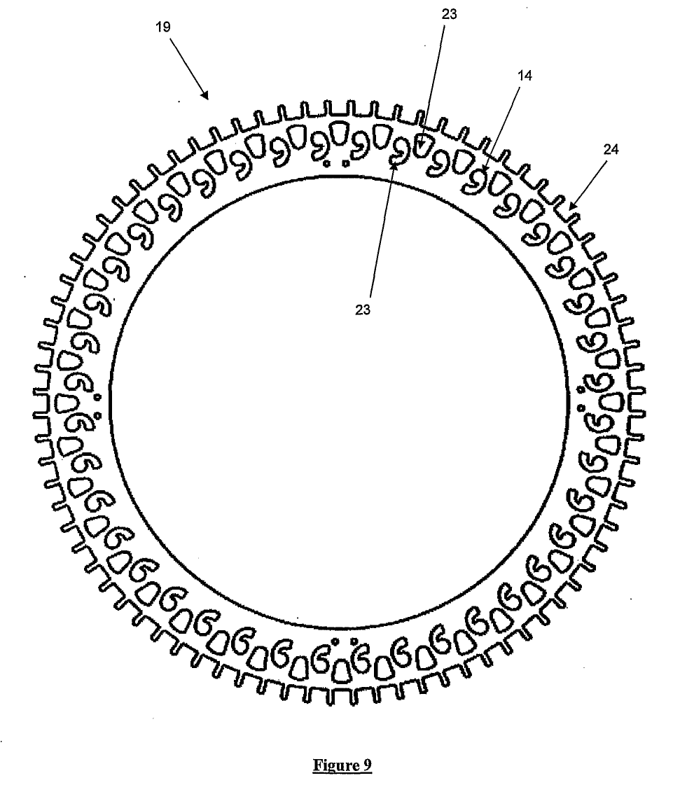

FIGS. 8 and 9 are plan views of disks for use in a disk stack for a valve of the invention;

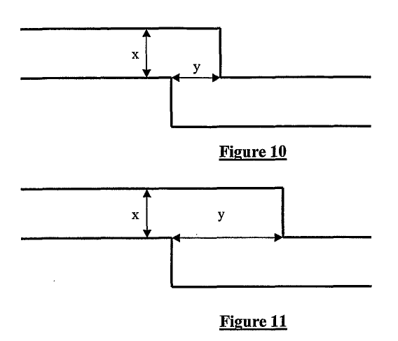

FIGS. 10 and 11 are sectional views showing details of the outlet labyrinth for use in a valve of the invention.

Referring to FIGS. 1, 2, 3 and 4 a vortex chamber 1 with associated curved inlet flowpath 2 is shown, the inlet flowpath cross sectional area reducing from its inlet to its throat 4. The fluid enters the inlet path at the inlet 3 and as it flows through the curved inlet flowpath 2 it accelerates as it changes direction. To further enhance this acceleration the inlet flowpath 2 decreases in cross sectional area from its inlet 3 to its throat 4. The vortex chamber may be substantially cylindrical with the inlet flowpath 2 entering it substantially tangentially or as shown in FIG. 2 the vortex chamber 1 may be substantially spiral in form with the tail of the spiral extending from the vortex chamber 1 to at least partially define the inlet flowpath. The decrease in cross sectional area accelerates the fluid passing through it. The fluid contains a certain amount of energy so as it accelerates its pressure decreases to maintain its same energy. When the fluid enters the vortex chamber 1 it further accelerates as it assumes a reducing spiral vortex towards the outlet 5. In FIGS. 2 and 3 as the fluid exits the vortex chamber 1 it enters an exit flowpath 6 of expanding cross sectional area. The exit flowpath 6 has a torturous passage formed of several 90 degree bends 7 8 through which the fluid passes. As the fluid passes through the torturous path it fully expands so there is no increase in velocity as the fluid exits the outlet flow path 6 at the exit 9.

Referring to FIG. 5 an example of a disk stack trim of a fluid control valve is shown as common in the art comprising a valve body 10 with a inlet 11 and outlet 12 in fluid communication with one another via a central chamber 13 containing seat ring 14, disc stack 15 and plug 16. When the valve plug 16 sits on the valve seat ring 14 no flow is permitted to pass through the valve. As the plug 16 lifts up in a controlled movement flow is allowed to enter the valve through inlet 11, pass through the disk stack 15 which reduces the fluid pressure and out of outlet 12.

Referring to FIG. 6 a plurality of inlets lead 13 to associated vortex chambers 14, each curved inlet flowpath 15 being fed by two fluid inlets 13 which impinge and flow together through the curved inlet flowpath. In the vortex chamber 14 the flow splits into two, each part spiralling towards one of the two outlets 16 on opposed faces of the chamber and exiting therethrough. The flow from the lower outlet of one vortex chamber then impinges with the flow from the upper outlet of the vortex chamber situated beneath it and the two flows separate and impinge as they flow through the outlet labyrinth 17.

Referring to FIGS. 7, 8 and 9, an exploded view of a possible construction of an interlinked single stage, restricted curved inlet flowpath pressure control with outlet labyrinth is shown constructed of a number of pair's individual elements 18, 19. Elements 18 contain inlets 13, vortex exit holes 16 and a section of the outlet labyrinth 20. Elements 19 contain the curved inlet flowpath 15 and vortex chambers 14, the first part of the labyrinth 23 and labyrinth exit 24, parts 22, 23 and 24 forming the outlet labyrinth 17. As the disk stack is assembled plate elements 18 and 19 must be aligned to ensure interconnection between the vortex chambers and the labyrinths. It will be appreciated that an additional piece (not shown) will be required on the completed disk capping off the top and bottom. The elements are all joined together to form the completed control valve trim stack.

Referring to FIGS. 10 and 11 a detail of a labyrinth turn consisting of two 90 degree turns is shown. Typically in a pressure reduction labyrinth dimension x is approximately equal to dimension y such that the fluid passes through 90 degree angles (FIG. 10). Where the labyrinth is being used to expand the gas before it exits the valve then dimensions are used where y is greater than x such that the fluid passes through less than 90 degree turns (FIG. 11).

1-17. (canceled)

18. A fluid flow control valve comprising a plurality of vortex, fluid pressure reduction chambers, each vortex chamber having an inlet in the form of a curved flowpath having an inlet orifice of defined cross sectional area which decreases along the length of the inlet flowpath to a minimum point at a throat close to which it opens into the vortex chamber, the fluid flow within the vortex chamber taking a generally spiral flow path having both radial and axial components from the inlet towards an outlet positioned substantially axially at an end of the vortex chamber, the curvature of the inlet flowpath being such that the direction of the flow therein is in substantially the same direction as the radial component of the flow within the vortex chamber.

19. A fluid flow control valve according to claim 18, wherein the inlet flow from the curved inlet flowpath is substantially tangential to the outer surface of the vortex chamber, thereby continuing the radial flow path and minimising any turbulence at the point of entry of the fluid into the vortex chamber.

20. A fluid flow control valve according to claim 18, wherein the vortex chamber is substantially cylindrical and the outlet is positioned on the central axis at an end of the vortex chamber, the outlet being smaller in dimension than the end of the vortex chamber

21. A fluid flow control valve according to claim 18, wherein the vortex chamber is substantially cylindrical and the outlet is positioned on, and at one end of, the central axis of the chamber, the outlet being equal in dimension to the end of the vortex chamber.

22. A fluid flow control valve according to claim 18, in which the vortex chamber is substantially spiral in shape.

23. A fluid flow control valve according to claim 22, in which the spiral forming the vortex chamber extends beyond the vortex chamber to at least partially define the inlet flowpath.

24. A fluid flow control valve according to claim 18, wherein each vortex chamber has one inlet for the fluid and two outlets for the fluid.

25. A fluid flow control valve according to claim 18, wherein the outlet of the vortex chamber forms the inlet to a labyrinth of passageways in which the fluid can expand further.

26. A fluid flow control valve according to claim 25, wherein the labyrinth consists of a series of substantially 90 degree bends.

27. A fluid flow control valve according to claim 26, wherein the 90 degree bend flowpaths are dimensioned such that the fluid flow path passing through them does so at an angle less than 90 degrees.

28. A fluid flow control valve according to claim 18, wherein said valve comprises disks defining a plurality of vortex chambers.

29. A fluid flow control valve according to claim 28, wherein the vortex chambers are located radially on a disc with a central concentric hole, the fluid inlet and fluid outlets being located on, respectively, the inner and outer diameters of the disc.

30. A fluid flow control valve according to claim 29, wherein the discs consist of a plurality of elements placed on top of one another with details in their surfaces to create the desired geometry of the vortex chambers and the fluid inlet and fluid outlets when the elements are placed together.

31. A fluid flow valve according to claim 29, wherein the discs are brazed or joined together by other means to form a disc stack control element in the shape of a cylinder with a concentric bore running along its axis and a plurality of fluid inlets and fluid outlets located on the inner and outer surfaces of the disc stack, the amount of the trim exposed to the flow being controlled by a plug or plunger movable in the concentric bore of the disc stack such that it can cover and expose a varying number of fluid flow paths with associated pressure reducing chambers.

32. A fluid flow valve according to claim 28, wherein the outlets of the vortex chambers within a disc stack are in fluid communication with one another.

33. A fluid flow valve according to claim 28, wherein two or more vortex chambers are joined in series with one another such that the outlets of one vortex chamber are connected to the inlets of the next series of vortex chambers.

34. A fluid flow valve according to claim 28, wherein the outlet path from the vortex chambers has an increasing cross sectional area.
